(19) United States
(12) Patent Application Publication
(10) Pub. No.: US 2007/0168910 A1
(43) Pub. Date: Jul. 19, 2007

(54) Automatic sizing of software functionality

(75) Inventors: Paul Frank Radford, Victoria (AU); Robyn Nancy Lawrie, Victoria (AU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: CHARISMATEK SOFTWARE METRICS PTY LTD, Victoria (AU)

(21) Appl. No.: 10/553,157

(22) PCT Filed: Apr. 8, 2004
(86) PCT No.: PCT/AU04/00469

§ 371 Date: Dec. 4, 2006

(30) Foreign Application Priority Data
Apr. 10, 2003 (AU) 2003901714

(51) Int. Cl. G06F 9/44

(52) U.S. Cl. 717/101; 717/104

(57) ABSTRACT

A method for assessing a functional size of a software application or project which includes the step of analysing a software requirements specification and determining zero or more keywords for each requirement of the specification. A computer is used to cross-reference the keywords with a lexicon stored in a computer file, and the lexicon also includes a function type and complexity for each keyword. The computer is further used to associate each keyword with an entry in the lexicon, thus obtaining a function type and complexity for each keyword. A functional sizing standard is used to deduce a number of function points for the function type and complexity of each keyword. The function points are combined to obtain a functional size of the software application or project. Computer implemented systems and computer program products for carrying out the method are also provided.

### FIELD OF THE INVENTION

The invention relates generally to software measurement and estimation, and in particular to a method and apparatus for assessing the Functional Size of a software application based upon the software requirements.

### BACKGROUND OF THE INVENTION

Within the information technology (IT) industry, it is important to be able to estimate parameters such as the projected development time and cost required to complete a software project, for the purposes of project management, budgeting, business case evaluation and support and/or other business initiatives. In order to make such estimates, it has become common to first establish a quantity usually referred to as the “Functional Size” of the software, based upon software requirements typically defined in business terminology.

The Functional Size is usually independent of the development environment and technology used to build a software application. Extensive research and practical application have demonstrated that the Functional Size has a direct and consistent relationship to the effort required to design, build and support software applications.

Once the Functional Size has been assessed, the results may be used as the basis for the extrapolation of parameters such as the time, effort or cost associated with development. The most common form of extrapolation is the simple and direct multiplication of the Functional Size by an anticipated overall productivity rate, which may be dependent upon, and vary with, the technology used and other factors present in the development environment.

The most widely accepted method for assessing the Functional Size of a software application is Function Point Analysis. Function Point Analysis evaluates an application's capabilities from the point of view of the end user. It is thus possible to use a formal Requirements Specification of the application as the starting point for Function Point Analysis, although, an analysis can be performed based on other types of documentation describing a computer software application.

Function Point Analysis involves assessing the number of “Function Points” corresponding to the required functionality of a software application. This requires the elements of functionality required within the application to be identified and classified, such that a number of Function Points can be associated with each element. There are several variants of this process, however the most common is the International Function Point Users Group (IFPUG) Counting Practices method. This method is normally performed by experts who are skilled and experienced with respect to the application of this technique. Accordingly, effective implementation of software sizing using Function Point Analysis requires the involvement of people with sufficient up-to-date expertise and experience. The sizing and estimation process is therefore generally perceived to be an additional burden and overhead on the software development process that involves additional time and expense and requires the input of experts who are skilled in performing such processes.

Accordingly there exists a need to improve the process of assessing Functional Size in order to reduce or eliminate the constant need for expert practitioners, and to reduce the cost, time and inconvenience associated with assessing Functional Size. Prior art methods for Functional Size estimation include: sizing from code; generation from Computer Aided Software Engineering (CASE) tools; expert system tools; and software tools with advanced user interfaces.

The method of sizing from code is based on using software tools to analyse program code in an attempt to identify functionality from indications of transactions that are present in the code. However, this process is fundamentally flawed in concept and impractical in practice. Any actual code is highly dependent for its form upon the style and technique of an individual programmer. The same functionality may be implemented by different programmers in dramatically different ways, making it impossible to create an analysis tool that is able to produce consistently reliable estimates of Functional Size from code. The required relationship between functional sizing artifacts and code artifacts simply does not exist. Studies carried out by the David Consulting Group in the USA indicate size estimates using this method may be around 500% of actual size. Furthermore, although there are some uses for Functional Size estimates generated after the application has been built, such as estimating ongoing support and maintenance costs, an estimate generated from code is usually too late for the vital purpose of projecting development cost and time.

The concept of generating size estimates from CASE tools is intended to improve upon the method of sizing from code by using data held within a design automation tool. This data is generally available earlier in the development process, and is less idiosyncratic than program code. Even so, the logical view of the software which is required for good functional sizing is quickly lost in the artifacts generated by CASE tools. Consequently, attempts to improve size estimation in this way have suffered from many of the same problems in accuracy experienced with sizing from code. Studies carried out by the David Consulting Group in the USA indicate size estimates using this method are often around 300% of actual size.

Since effective functional sizing is most commonly performed by experts applying rules such as those of the IFPUG Counting Practices Rules Committee, another approach to improving the process has been to build these rules directly into an Expert System. However, the complexity of the rules, and the problems of translating the language in which they are expressed into a form required for implementation has led to results that are largely unworkable, too slow, clumsy and impractical for most serious applications. Consequently, they have failed to solve the problem of the additional time and expense associated with estimating Functional Size.

In another attempt to solve these problems, the work of functional sizing experts is “streamlined” through the use of software tools providing an advanced user interface for the entry and management of functional information. At their most effective, such tools provide a “point and click” approach to classification, and useful defaults for complexity of functions, enabling an operator to perform an analysis more quickly, efficiently and consistently than would be possible by hand, or using less sophisticated tools. However, even the most advanced tools do not integrate completely with existing practices and CASE tools, and there is still a need for substantial expertise on the part of a user. Thus provision of an advanced user interface is only a partial solution to the problem, which does not enable the process to be performed without the assistance of skilled personnel.

It is accordingly an object of the present invention to provide a method of assessing the Functional Size of a software application that mitigates one or more of the disadvantages in the prior art.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

In one aspect, the present invention provides a method for assessing a functional size of a software application or project including the steps of:

analysing a software requirements specification and determining zero or more keywords for each requirement of the specification;

using a computer to cross-reference the keywords with a lexicon stored in a computer file, said lexicon also including a function type and complexity for each keyword, and further using the computer to associate each keyword with an entry in the lexicon, thus obtaining a function type and complexity for each keyword;

using a functional sizing standard to deduce a number of function points for the function type and complexity of each keyword; and

combining the function points to obtain a functional size of the software application or project.

Accordingly, the method enables a functional size of a software application to be assessed prior to the development of any actual code in a manner that is independent of the style and technique of any programmer, and of the development environment and tools that will be used. Since the assessment is based upon the requirements specification, it is readily integrated into the overall software definition and development process. Furthermore, since the method incorporates the use of a suitable functional sizing standard, when implemented in preferred manners it may reduce or entirely eliminate the need to engage the services of a human expert to analyses the application and apply the sizing rules.

It is preferred that the step of analysing the requirements specification includes parsing each requirement to at least isolate lexical elements and determining at least one keyword corresponding to each lexical element. It will be appreciated that in this context, the term “parsing” will be understood by persons of skill in the art to have a broad meaning, encompassing a range of possible methods for processing a requirement.

It is further preferred that the step of cross-referencing a keyword with the lexicon includes searching the lexicon for an entry which matches said keyword.

The lexical elements may be individual words of a requirement. Of course, it will be appreciated that the lexical elements may be phrases or other identifiable grammatical constructs that signify key attributes of a requirement, such as the type of transaction that it represents.

In a preferred embodiment, determining keywords for a requirement includes identifying words in the requirement that appear in the lexicon. However, a skilled person will appreciate that it is also possible to identify abbreviations, synonyms or even typographical variations or misspellings. More sophisticated parsing may be employed to infer keywords from phrases and/or other grammatical constructs appearing in a requirement.

It is particularly preferred that the sizing standard be a standard maintained by the International Function Point Users Group (IFPUG). Advantageously, the method may thus provide automatic sizing of a software application from requirements according to an established standard, without the necessary involvement of an expert in the application of the standard.

The function type associated with a keyword in the lexicon may be one of Internal Logical File, External Interface File, External Input, External Output or External Inquiry, and the complexity associated with each keyword may be one of Low Complexity, Average Complexity or High Complexity. Of course, many alternative function types and complexity scaling may be used.

Preferably, the step of combining the function points includes summing the function points associated with all identified keywords to obtain a functional size that is equal to the total number of function points.

In preferred embodiments, the method further includes the step of deducing from the functional size at least one parameter associated with management of the development of the software application, which parameter may be one or more of cost, effort, and/or development time. The step of deducing the at least one parameter may include, for example, multiplying the functional size by a number representing a corresponding productivity rate, however it will be appreciated that many other methods of calculating parameters derived from the functional size may be employed.

In another aspect, the present invention provides a computer implemented system for assessing a functional size of a software application or project, wherein the system receives a software requirements specification as input and includes:

a lexicon stored in a computer file, the lexicon including keywords and a function type and complexity for each keyword;

computer instruction code for analysing the software requirements specification to associate each requirement with zero or more requirement keywords;

computer instruction code for cross-referencing the requirement keywords with the lexicon to obtain a corresponding function type and complexity from the lexicon by matching requirement keywords with lexicon keywords;

computer instruction code for computing a number of function points associated with each function type and complexity using the rules of a sizing standard; and

computer instruction code for combining the function points to obtain a functional size of the software application or project.

It is preferred that the software requirements specification is able to be received as input using a virtual clipboard of a personal computer by a user performing a cut and paste operation from a source application. Alternatively or additionally, input may be from a file stored on a non-volatile storage medium of a personal computer. It is also possible that the system may be connected to a communications network and the software requirements specification may then be received as input from a remote source over the network.

It is particularly preferred that the system further includes a lexicon editor for enabling a user to modify the computer file in which the lexicon is stored, such that the lexicon keywords and corresponding function type and complexity can be changed, and new lexicon keywords and their corresponding function type and complexity can be added.

The lexicon keywords may be words that may appear in requirements of the requirements specification. The function type associated with a keyword and stored in the lexicon may be one of Internal Logical File, External Interface File, External Input, External Output or External Inquiry, and the complexity associated with each keyword and stored in the lexicon may be one of Low Complexity, Average Complexity or High Complexity.

In yet another aspect the present invention provides, in a networked computing system including a client and a server both of which are operably connected to a communications network, a method for assessing a functional size of a software application or project including the steps of:

the client transmitting a software requirements specification to the server over the communications network; and

the client receiving a functional size of the software application or project from the server over the communications network,

wherein the server executes the steps of:

analysing a software requirements specification and determining zero or more keywords for each requirement of the specification;

cross-referencing the keywords with a lexicon stored in a computer file, said lexicon also including a function type and complexity for each keyword;

associating each keyword with an entry in the lexicon, thus obtaining a function type and complexity for each keyword;

using a functional sizing standard to deduce a number of function points for the function type and complexity of each keyword; and

combining the function points to obtain a functional size of the software application or project.

In a further aspect, the present invention provides a computer program product for assessing a functional size of a software application or project including computer instruction code embodied in a computer readable medium for:

analysing a software requirements specification and determining zero or more keywords for each requirement of the specification;

cross-referencing the keywords with a lexicon stored in a computer file, said lexicon also including a function type and complexity for each keyword;

associating each keyword with an entry in the lexicon, thus obtaining a function type and complexity for each keyword;

using a functional sizing standard to deduce a number of function points for the function type and complexity of each keyword; and

combining the function points to obtain a functional size of the software application or project.

In a preferred embodiment, the computer program product further includes computer instruction code embodied on the computer readable medium for deducing from the functional size at least one parameter associated with management of the development of the software application. The parameter may be, for example, one or more of cost, effort, and/or development time. Deducing the at least one parameter includes multiplying the functional size by a number representing a corresponding productivity rate.

It is preferred that the software requirements specification is able to be received as input using a virtual clipboard of a computer executing the computer instruction code by a user performing a cut and paste operation from a source application. Of course, other methods of entering the software requirements specification may be provided, such as reading the specification from a file or receiving the specification over a communications network.

Preferably, the computer program product further includes computer instruction code embodied on the computer readable medium for providing a lexicon editor that enables a user to modify the computer file in which the lexicon is stored, such that the lexicon keywords and corresponding function type and complexity can be changed, and new lexicon keywords and their corresponding function type and complexity can be added.

### BRIEF DESCRIPTION OF THE DRAWINGS

Preferred embodiments of the invention will now be described, without limiting the overall scope of the invention, with reference to the accompanying drawings in which:

FIG. 1 is a logical data flow diagram illustrating an exemplary system for assessing the Functional Size of a software application or project;

FIG. 2 shows a lexicon keyword list window of a computer software application implemented according to a preferred embodiment of the invention;

FIG. 3 shows a dialog box of the software application enabling a user to add a keyword to the lexicon;

FIG. 4 shows a dialog box of the software application enabling a user to set default complexity ratings for function types;

FIG. 5 illustrates a graphical display of the software application showing transaction nodes corresponding to a set of input requirements;

FIG. 6 shows a keyword parsing dialog box of the software application;

FIG. 7 illustrates a graphical display of the software application showing transaction nodes corresponding to a set of input requirements including function points automatically assigned in accordance with a preferred embodiment of the invention;

FIG. 8 shows a function point summary dialog box of the software application;

FIG. 9 is a contents section from a spreadsheet including hierarchically structured requirements headings;

FIG. 10 illustrates a graphical display of the software application showing transaction nodes corresponding to the hierarchical requirements headings of FIG. 9;

FIG. 11 illustrates a graphical display of the software application showing the transaction nodes of FIG. 10 including function points automatically assigned in accordance with a preferred embodiment of the invention; and

FIG. 12 shows a function point summary dialog corresponding to the assignments of FIG. 11.

### DESCRIPTION OF PREFERRED EMBODIMENT

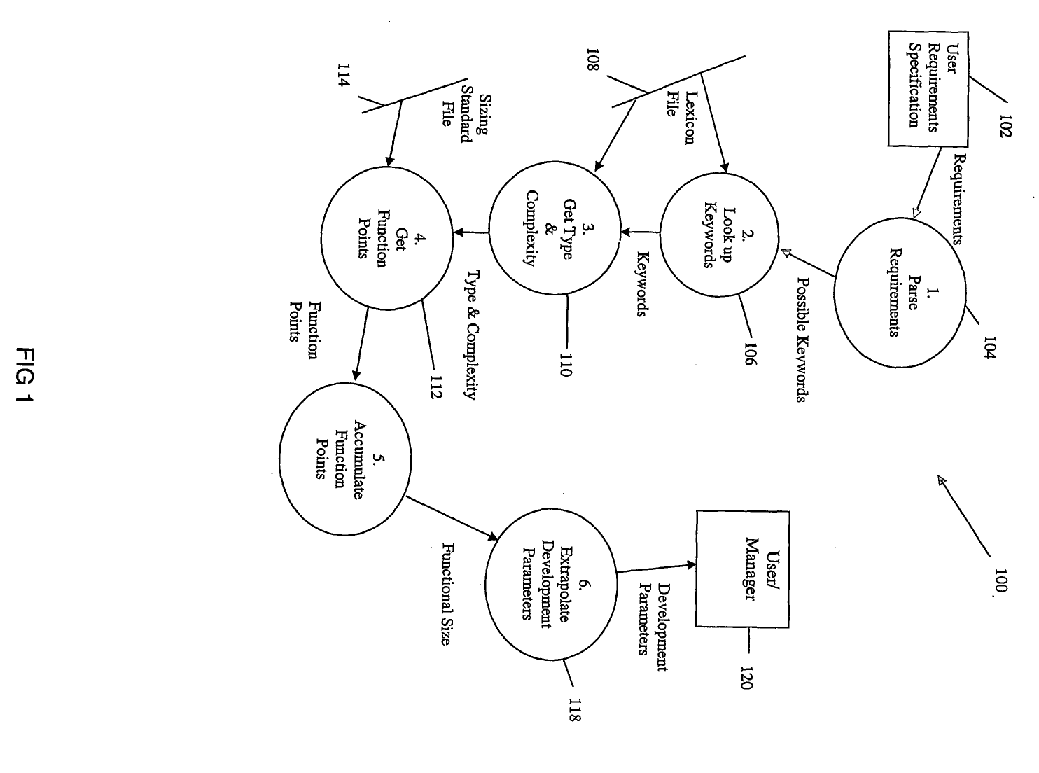

FIG. 1 illustrates an exemplary system 100 for assessing the Functional Size of a software application in the form of a logical data flow diagram. In the exemplary embodiment, the main source of information to be analysed and processed by the system is a Requirements Specification document 102 containing the base requirements of the user. The Requirements Specification defines a list of statements defining the functional features that are to be implemented in the software application.

Each requirement in the specification is input to a process 104 that parses the requirement to identify possible keywords that are associated with the requirement. In one embodiment of the invention, the parsing process 104 extracts individual words or phrases from the requirement. However in other embodiments the parsing process 104 may perform more sophisticated analysis of the text of the requirement in order to infer possible keywords. The parsing process 104 may also be able to identify portions of the requirement text that perform other functions, such as identifying the objects or elements within the software application to which the functional requirement refers.

The extracted list of possible keywords is passed to a keyword look-up process 106, the function of which is to search a lexicon file or database 108 for any entries corresponding to the keywords. In the preferred embodiment, the keywords in the lexicon are ordinary words chosen on the basis of their probable association with specific functional elements defined by the Requirements Specification. If no corresponding keywords are found, then the requirement is assumed to consist of a linking component that does not specify any functional element with which a size is associated. In this case, no further processing is performed, and the system will continue processing the next requirement.

If any keyword is found in the lexicon 108, it is passed to a process 110, the function of which is to determine a classification for the functional element of the software application represented by the keyword. In the preferred embodiment, the classification consists of a function type and a complexity, which are stored in the lexicon 108 along with the corresponding keyword. More particularly, in the common method of Function Point Analysis, the function type is either a Data Function or a Transactional Function. Data Functions are either Internal Logical Files or External Interface Files, while Transaction Functions are one of External Inputs, External Outputs, or External Inquiries. The complexity is then one of Low, Average or High. Thus an example of a valid classification is “External Inquiry of Average Complexity.”

Once the classification of the functional element has been determined, it is passed to a process 112, the purpose of which is to deduce the Function Point Value of the functional element based on its classification. In the preferred embodiment, the Function Point Value is obtained by the use of a Sizing Standard, such as the International Function Point Users Group Guidelines. The required data corresponding to the chosen standard may be stored in a file or database 114 for look up by the process 112.

The Function Point Values are input to a function point accumulation process 116. In the presently preferred embodiment, this process calculates the sum of all the input Function Point Values, however it will be appreciated that other methods for accumulating the Function Point Values are possible.

The output of the process 116 is an overall Functional Size for the software application, which may be input to a parameter extrapolation process 118. The function of the extrapolation process 118 is to compute one or more parameters associated with management of the development of the software application or project. The parameters that could be computed include cost, development effort or development time. In one embodiment, any of these parameters may be obtained by multiplying the Functional Size by a number representing a corresponding productivity rate. It will be appreciated by those skilled in the art that more sophisticated calculations may be used that include factors such as the variations of productivity in different environments.

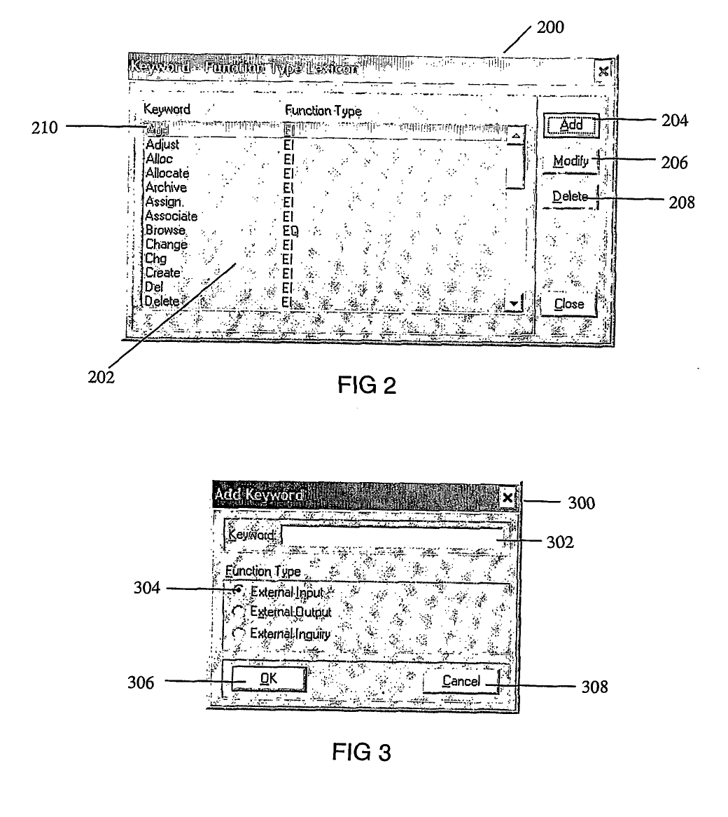

An exemplary embodiment of the invention will now be described with reference to FIGS. 2 to 12. This embodiment is a computer software program that has been developed for use on a personal computer running a version of the Microsoft Windows operating system, although it will be appreciated by those skilled in the art that the system could equally be implemented as a program for use on other hardware and operating system platforms.

A Requirements Specification is generally a separate document generated as part of the overall software development process, and as such it is more convenient for the user to enter a complete set of requirements that are created and maintained using another software application, such as a word processing program, spreadsheet program, or requirements definition program. In this regard, suitable commercially available source applications include Word or Excel from Microsoft, Requisite Pro from Rational and DOORS from Telelogic. The method of entry of the requirements may be by importing the requirements document from a file generated by the source application, or simply by using the standard cut-and-paste facility provided by the Windows clipboard. The exemplary embodiment also enables a user to manually enter each requirement for processing, by selecting functions from the lexicon. The lexicon may therefore be used to assist in the creation of a software requirements model, as well as in the automatic sizing of the model. It will be understood, however, that the provision of this additional functionality is not essential to the present invention.

The lexicon used by the program is a file or database that is itself accessible and extendible to the end user.

FIG. 2 illustrates a list of keywords and corresponding function types that are stored in the lexicon and displayed by the program to the user. A window 200 includes a list 202 of keywords and function types, and buttons 204, 206 and 208 are provided to enable the user to add, modify and delete keywords in the lexicon respectively. As shown in the list, the lexicon contains, for example, a keyword “add” 210 that is associated with a transaction of type External Input (EI). The add button 204 enables the user to enter new keywords and associated classifications into the lexicon.

FIG. 3 shows a dialog box 300 that is displayed to the user of the program after activating the “add” button 204. The dialog box 300 includes a keyword text entry field 302 and a set of function type radio buttons 304. The user enters the text of the keyword to be added into the text entry field 302 and specifies the associated function type by selecting the appropriate radio button 304. Once these details have been entered, the lexicon may be updated with the new entry by activating the “OK” button 306. To cancel entry of the new keyword, the user activates the “cancel” button 308.

The complexity associated with each function type depends upon the nature of the software application, and is preferably determined in accordance with a sizing standard, such as the IFPUG 4.1 standard.

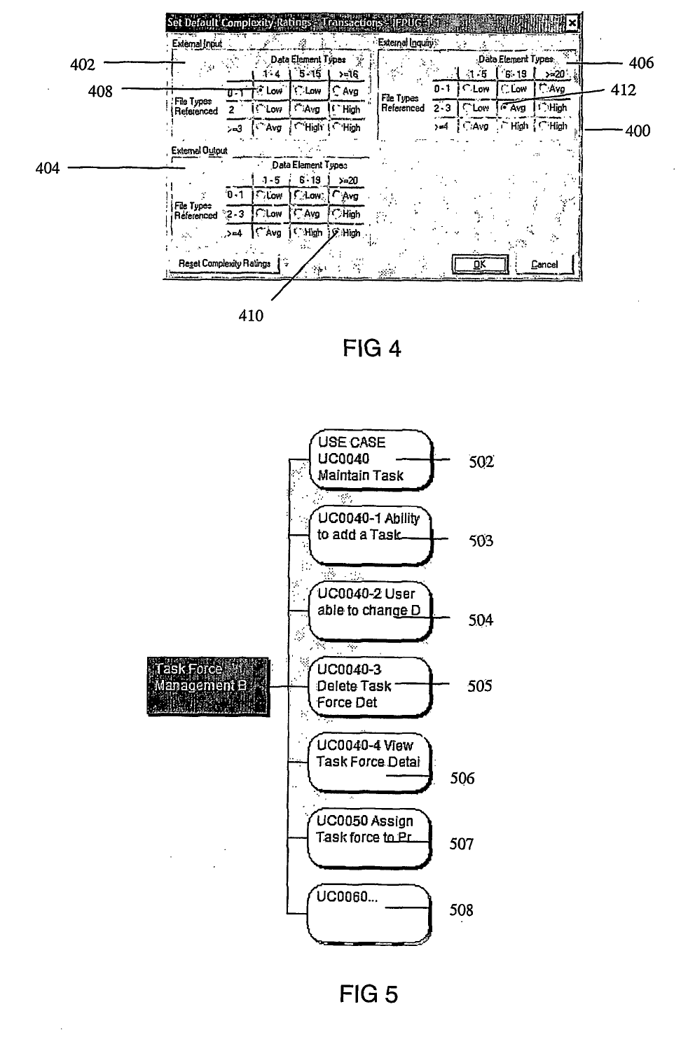

FIG. 4 illustrates a dialog box 400 that is provided by the exemplary embodiment to enable the user to set default complexity ratings according to this standard. For each of the transaction types External Input, External Output, and External Inquiry, the dialog box provides a corresponding table 402, 404, 406. Each table includes columns corresponding to the number of data element types required to be handled by the transaction, and rows corresponding to the number of file types referenced. The default complexity corresponding to each function type is generally higher when the number of data element types and/or file types is higher. Accordingly, the user selects within each table a radio button, eg 408, 410, 412, in accordance with the requirements of the particular software application whose functional size is to be determined. In the example shown in FIG. 4, the default complexity of External Inputs is Low, the complexity of External Outputs is High, and the default complexity of External Inquiries is Average.

It will, of course, be appreciated that the means provided for the user to update the lexicon illustrated in FIGS. 2 to 4 is merely exemplary, and that an alternative method may equivalently be provided, such as the provision of a bulk input facility in which new keywords and classifications are inserted from a file, or using a cut and paste facility from a source application such as a word processor or spreadsheet program. Furthermore, access to the lexicon may be provided by a separate application program, rather than from within the sizing application program as is implemented in the exemplary embodiment.

Use of the exemplary embodiment of the invention to automatically size the functionality represented by a set of simple functional requirements is now described with reference to a simple example. As far as is relevant to the present example, the lexicon includes the following entries, possibly amongst many others:

Keyword: “add” Classification: External Input of Low Complexity;

Keyword: “delete” Classification: External Input of Low Complexity;

Keyword: “change” Classification: External Input of Low Complexity;

Keyword: “assign” Classification: External Input of Low Complexity;

Keyword: “view” Classification: External Inquiry of Average Complexity.

An exemplary specification of a software component intended to manage a human resources database containing task force deployment details is based on use cases, and includes the following functional requirements:

USE CASE UC0040 Maintain Task Force

UC0040-1 Ability to add a Task Force Name and Details

UC0040-2 User able to change Details

UC0040-3 Delete Task Force Details capability required.

UC0040-4 View Task Force Details

UC0050 Assign Task force to Project

UC0060. . . .

In this example, the functional requirements have been entered into a Microsoft Word document, which is one of the most common tools used to create requirement definitions. The exemplary requirements are typical examples of software definitions, and it will be appreciated that it would ideally be possible to produce requirements that are more consistent in their structure. In practice, such ideal definitions are rarely produced, especially when there are many people involved in the software definition process. However, it is a particular advantage of the present invention that consistency is not essential, since the requirements are analysed as a whole to identify relevant keywords.

The requirements may be entered into the automated sizing program simply by cutting and pasting the requirements from the Word document. The result of doing so using the exemplary embodiment of the invention is illustrated in FIG. 5, which shows in a graphical form the set of transaction nodes created by the program. Each of the nodes 502 to 508 corresponds to one of the requirements in the exemplary specification.

The user then selects the appropriate function within the program to run the automatic sizing engine by requesting automatic assignment of function types.

Each imported transaction text item is then parsed by the program to identify possible keywords, which are then compared with the keywords stored in the lexicon. When a keyword is found in the lexicon, the program extracts the associated classification information, and updates the transaction with the corresponding type and complexity.

In the present example, transaction 502 contains no keywords that are included within the lexicon. Transactions 503 to 507 include the keywords “add”, “change”, “delete”, “view”, and “assign” respectively. The final transaction, labelled UC0060 contains no recognised keywords. Accordingly, following parsing and automatic assignment, five transactions include matches and are updated, while the final two transactions 502, 508 contain no keyword match and remain unclassified.

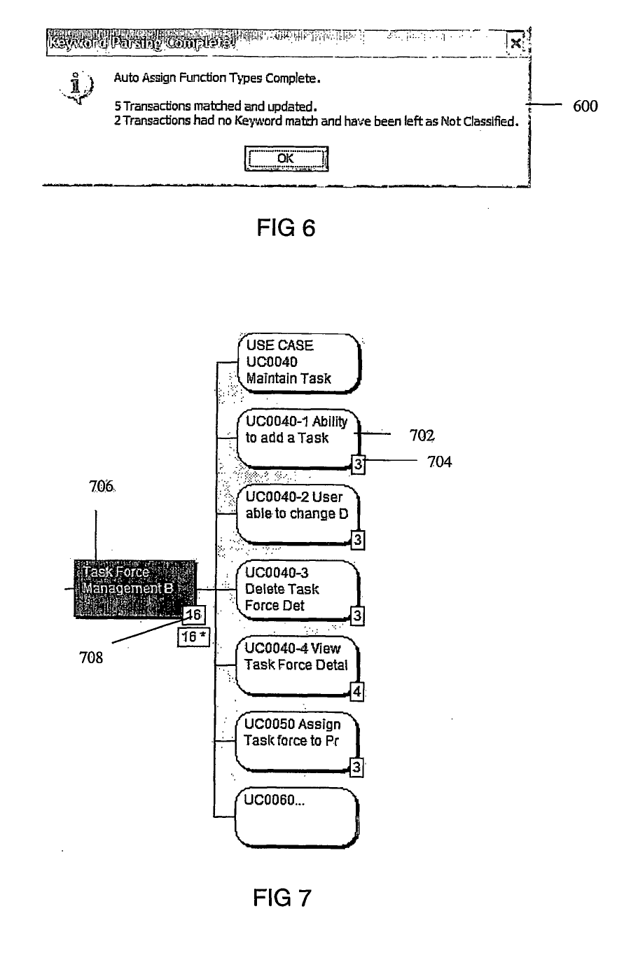

FIG. 6 shows the dialog box 600 generated by the program following completion of keyword parsing and automatic assignment.

Establishment of the functional size of the transactions is completed through the use of a sizing standard. Assuming the IFPUG guidelines are applied, External Inputs of Low Complexity are allocated the relative function point value of 3, while External Inquiries of Average Complexity are allocated the relative function point value of 4.

FIG. 7 shows the graphical representation of the transactions following allocation of function points. Each successfully matched transaction, eg. 702, now has associated with it a corresponding function point value which is displayed alongside the transaction, e.g. 704. The overall functional size of the “Task Force Management” object is obtained by summing the sizes of all of the subordinate transactions. The total, which in this case is 16 function points, is displayed in a box 708 along side the box 706 representing the object.

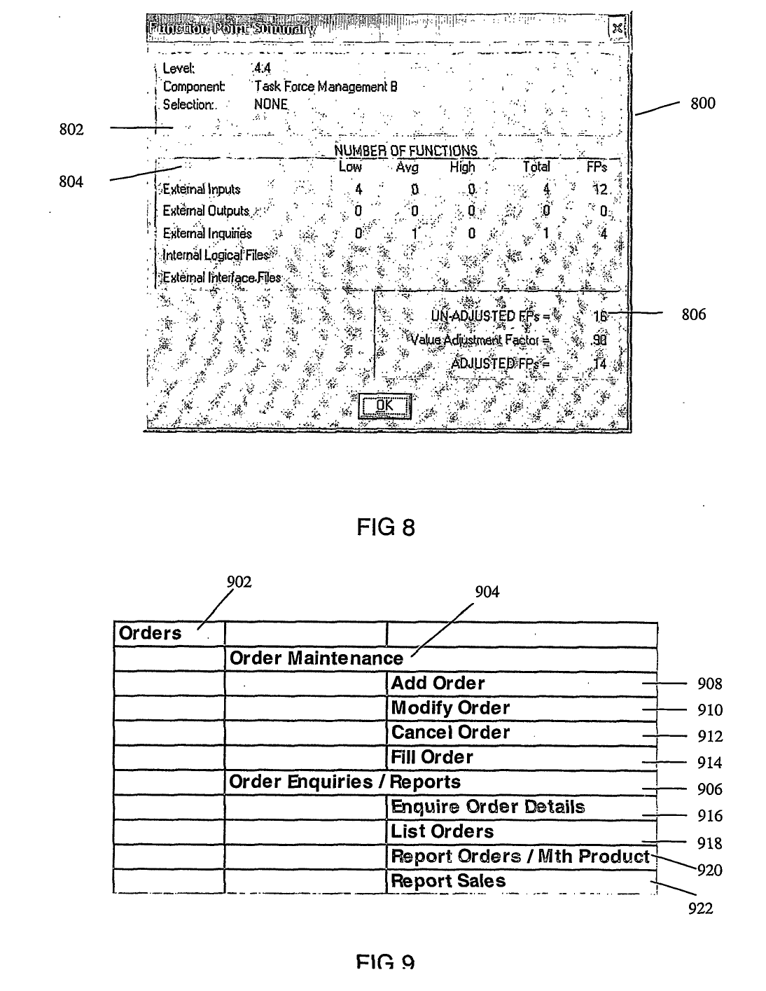

A function point summary dialog box 800, as illustrated in FIG. 8, is also displayed. The window 800 includes a pane 802 summarizing the details of the component for which the analysis has been carried out, a pane 804 including a table of all transaction types and totals, and a pane 806 including overall totals. In this case, the total unadjusted number of function points is 16, however the program allows a value adjustment factor to be applied, which is an additional parameter that may be used to account for local variations in the cost and/or value of development of the software components. In the example shown, a value adjustment factor of 0.9 has been applied, resulting in a final adjusted function point total of 14. The value adjustment factor may be applied on a component by component basis in order to account, for example, for differences in the cost of development of different components. Thus, for a large software application consisting of many components, multiple value adjustment factors may be applied in determining the overall adjusted function point total.

The Functional Size may then be used to estimate specific parameters of the software development process. For example, if an estimate of the development effort in person hours is required, a simple extrapolation based upon multiplication of the Functional Size by a suitable factor may be used. Accordingly, in the present example an estimate of around 50-60 person hours effort may be deduced assuming a simple environment, although it will be appreciated by those skilled in the art that more sophisticated extrapolations are possible using additional data to refine probable delivery rate productivity.

A further example of the use of the exemplary embodiment of the invention will now be described with reference to FIGS. 9 to 12. In this example, a requirements specification has been created within a Microsoft Excel spreadsheet defining the functionality required for maintenance and interrogation of a database of orders. In this case, the specification has been created with a meaningful hierarchical structure, and a table of contents generated from the requirements headings, a section of which is illustrated in FIG. 9. In the example, the order management component 902 consists of order maintenance 904 and order interrogation 906 subcomponents. The functionality to be provided in the order maintenance component includes adding 908, modifying 910, cancelling 912 and filling 914 orders that are sought in the order database. The functionality required of the order interrogation component includes enabling users to inquire 916 about details of orders, list 918 orders from the database, generate reports 920 in relation to orders and reports 922 in relation to sales.

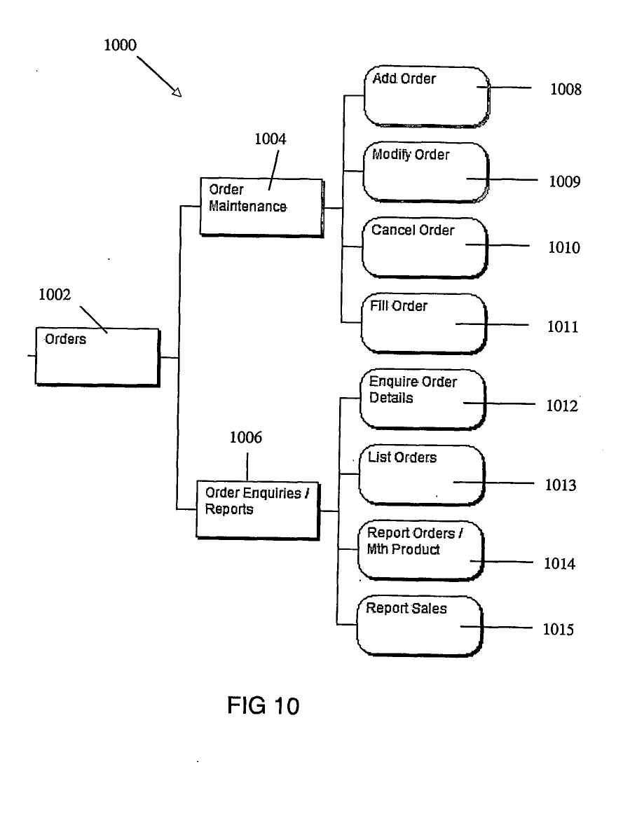

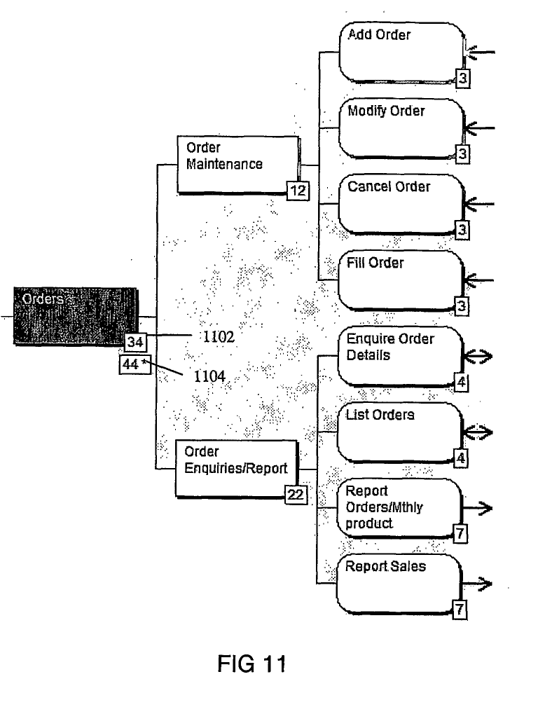

Upon selecting the hierarchically structured requirements, and cutting and pasting into the exemplary embodiment of the invention, the hierarchical structure is preserved as shown in FIG. 10. The graphical representation 1000 shows the orders component 1002, subordinate to which are the maintenance 1004, and interrogation 1006 subcomponents. Subordinate to the subcomponents are the transactions 1008 to 1015 corresponding to the functional requirements 908 to 922. The text associated with these transactions includes the keywords “add”, “modify”, “cancel”, “fill”, “inquire”, “list”, and “report”, all of which are held in the lexicon. Accordingly, the sizing engine is able to parse the text associated with each transaction and automatically assign function types according to the information stored in the lexicon. Therefore, by selecting the orders component and running the sizing engine the corresponding function point value will be automatically assigned to each transaction. The result is shown in FIG. 11, wherein the function point value is shown along side each transaction, the corresponding totals are shown alongside each subcomponent, and the overall total is shown alongside the main orders component. The total number of function points resulting from the eight transactions corresponding to the orders component is 34, as displayed in text box 1102. Furthermore, the orders database itself is assigned a function type of Internal Logical File of Average Complexity, contributing a further 10 function points which are included in the overall total displayed in text box 1104.

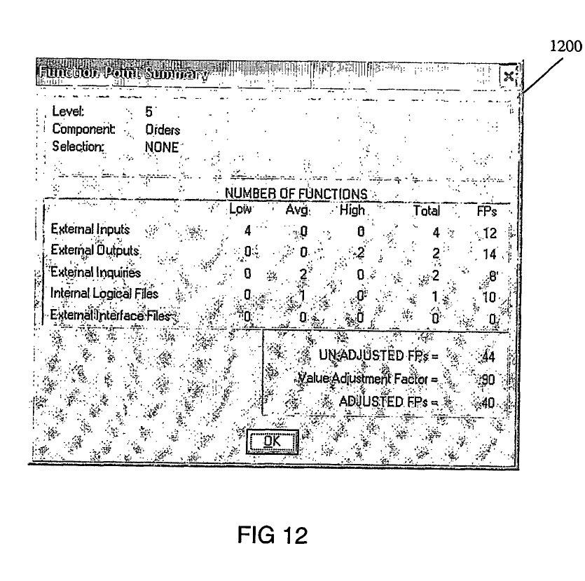

FIG. 12 shows the function point summary dialog box 1200 corresponding to the completed automatic assignment of function points illustrated in FIG. 11. Shown in the function table are four External Inputs of Low Complexity, corresponding to the add, modify, cancel and fill transactions. Two External Outputs of High Complexity correspond to the order and sales report. Two External Inquires of Average Complexity correspond to the inquire and list transactions. The single Internal Logical File of Average Complexity corresponds to the orders database itself. Overall, the total unadjusted function point value is 44, and after applying the value adjustment factor of 0.9, the total adjusted function points amount to 40.

Conclusion

The present invention details a method that may be embodied in a computer program and used to assess the Functional Size of a software application based upon a Requirements Specification document produced as part of the usual process of software development.

Accordingly, the problems associated with performing the size assessment as a separate task incurring additional time and expense may be mitigated. Furthermore, the dependence of the process upon experts with specialised skills, experience and knowledge is reduced. The ability, in a preferred embodiment, to modify and extend a lexicon used to identify and classify functional elements ensures that a system according to the present invention is sufficiently flexible to support the needs of a wide range of users and to enable improvements over time.

The present invention is not limited in scope to the described embodiment or embodiments, which are exemplary only. The scope of the invention will be understood to encompass variations, modifications and equivalents that would be apparent to persons of skill in the art, such as: employing other known methods of entering and parsing requirements and identifying corresponding keywords; using alternative sizing standards; and using other known methods for extrapolating Functional Size to obtain estimates of software development parameters.

For example, a method for assessing functional size in accordance with the invention could be implemented as a computer software program executing on a server connected to a communications network such as the internet. Such a sizing server could be designed to receive a requirements specification from a client program over the communications network, so that the server provides a remote or centralised functional sizing service. The lexicon used by the server may be located locally to the server, or alternatively may be located locally to the client or in a further remote location and accessed by the server over the communications network.

Furthermore, in the preferred embodiment a simple scale factor, the value adjustment factor, is provided to derive a final adjusted function point value from the unadjusted value. This scale factor may be used, for example, to convert the function point value into a parameter that is proportional to the function point value, such as an overall cost, effort or development time. In this case, the scale factor may be considered to be a corresponding productivity rate. However, it will be appreciated that once the function point value has been obtained, more sophisticated calculations may be employed to derive parameters of the software development process, and that further factors such as the variations of productivity in different environments may be included.

1. A method for assessing a functional size of a software application or project including the steps of:
analysing a software requirements specification and determining zero or more keywords for each requirement of the specification;
using a computer to cross-reference the keywords with a lexicon stored in a computer file, said lexicon also including a function type and complexity for each keyword, and further using the computer to associate each keyword with an entry in the lexicon, thus obtaining a function type and complexity for each keyword;
using a functional sizing standard to deduce a number of function points for the function type and complexity of each keyword; and
combining the function points to obtain a functional size of the software application or project.

2. The method of claim 1 wherein:
the step of analysing the requirements specification includes parsing each requirement to at least isolate lexical elements and determining at least one keyword corresponding to each lexical element; and
the step of cross-referencing a keyword with the lexicon includes searching the lexicon for an entry which matches said keyword.

3. The method of claim 2 wherein said lexical elements are individual words of a requirement.

4. The method of claim 1 wherein determining keywords for a requirement includes identifying words in the requirement that appear in the lexicon.

5. The method of claim 1 wherein the sizing standard is a standard maintained by the International Function Point Users Group (IFPUG).

6. The method of claim 1 wherein:
the function type associated with a keyword in the lexicon is one of Internal Logical File, External Interface File, External Input, External Output or External Enquiry; and
the complexity associated with each keyword is one of Low Complexity, Average Complexity or High Complexity.

7. The method of claim 1 wherein the step of combining the function points includes summing the function points associated with all identified keywords to obtain a functional size that is equal to the total number of function points.

8. The method of claim 1, further including the step of deducing from the functional size at least one parameter associated with management of the development of the software application.

9. The method of claim 8 wherein said at least one parameter is one or more of cost, effort, and/or development time.

10. The method of claim 8 wherein the step of deducing the at least one parameter includes multiplying the functional size by a number representing a corresponding productivity rate.

11. A computer implemented system for assessing a functional size of a software application or project, wherein the system receives a software requirements specification as input and includes:
a lexicon stored in a computer file, the lexicon including keywords and a function type and complexity for each keyword;
computer instruction code for analysing the software requirements specification to associate each requirement with zero or more requirement keywords;
computer instruction code for cross-referencing the requirement keywords with the lexicon to obtain a corresponding function type and complexity from the lexicon by matching requirement keywords with lexicon keywords;
computer instruction code for computing a number of function points associated with each function type and complexity using the rules of a sizing standard; and
computer instruction code for combining the function points to obtain a functional size of the software application or project.

12. The system of claim 11 wherein the software requirements specification is received as input by a user performing a cut and paste operation from a source application.

13. The system of claim 11 wherein the software requirements specification is received as input from a file stored on a non-volatile storage medium of a personal computer.

14. The system of claim 11 wherein the system is connected to a communications network and the software requirements specification is received as input from a remote source over the network.

15. The system of claim 11 further including a lexicon editor for enabling a user to modify the computer file in which the lexicon is stored, such that the lexicon keywords and corresponding function type and complexity can be changed, and new lexicon keywords and their corresponding function type and complexity can be added.

16. The system of claim 11 wherein the lexicon keywords are words that may appear in requirements of the requirements specification.

17. The system of claim 11 wherein the function type associated with a keyword and stored in the lexicon is one of Internal Logical File, External Interface File, External Input, External Output or External Enquiry and the complexity associated with each keyword and stored in the lexicon is one of Low Complexity, Average Complexity or High Complexity.

18. In a networked computing system including a client and a server both of which are operably connected to a communications network, a method for assessing a functional size of a software application or project including the steps of:
the client transmitting a software requirements specification to the server over the communications network; and
the client receiving a fuctional size of the software application or project from the server over the communications network,
wherein the server executes the steps of:
analysing a software requirements specification and determining zero or more keywords for each requirement of the specification;
cross-referencing the keywords with a lexicon stored in a computer file, said lexicon also including a function type and complexity for each keyword;
associating each keyword with an entry in the lexicon, thus obtaining a function type and complexity for each keyword;
using a functional sizing standard to deduce a number of function points for the function type and complexity of each keyword; and
combining the function points to obtain a functional size of the software application or project.

19. A computer program product for assessing a functional size of a software application or project including computer instruction code embodied in a computer readable medium for:
analysing a software requirements specification and determining zero or more keywords for each requirement of the specification;
cross-referencing the keywords with a lexicon stored in a computer file, said lexicon also including a function type and complexity for each keyword;
associating each keyword with an entry in the lexicon, thus obtaining a function type and complexity for each keyword;
using a functional sizing standard to deduce a number of function points for the function type and complexity of each keyword; and
combining the function points to obtain a functional size of the software application or project.

20. The computer program product of claim 19 wherein:
analysing the requirements specification includes parsing each requirement to isolate lexical elements and determining at least one keyword corresponding to each lexical element; and
cross-referencing a keyword with the lexicon includes searching the lexicon for an entry which matches said keyword.

21. The computer program product of claim 20 wherein said lexical elements are individual words of a requirement.

22. The computer program product of claim 20 wherein determining keywords for a requirement includes identifying words in the requirement that appear in the lexicon.

23. The computer program product of claim 19 wherein combining the function points includes summing the function points associated with all identified keywords to obtain a functional size that is equal to the total number of function points.

24. The computer program product of claim 19, further including computer instruction code embodied on the computer readable medium for deducing from the functional size at least one parameter associated with management of the development of the software application.

25. The computer program product of claim 24 wherein said at least one parameter is one or more of cost, effort, and/or development time.

26. The computer program product of claim 24 wherein deducing the at least one parameter includes multiplying the functional size by a number representing a corresponding productivity rate.

27. The computer program product of claim 19 wherein the software requirements specification is received as input using a virtual clipboard of a computer executing the computer instruction code by a user performing a cut and paste operation from a source application.

28. The computer program product of claim 19 further including computer instruction code embodied on the computer readable medium for providing a lexicon editor that enables a user to modify the computer file in which the lexicon is stored, such that the lexicon keywords and corresponding function type and complexity can be changed, and new lexicon keywords and their corresponding function type and complexity can be added.
